(19) United States
(12) Patent Application Publication
(10) Pub. No.: US 2005/0185775 A1
(43) Pub. Date: Aug. 25, 2005

(54) Method and apparatus for disconnecting an off-hook customer premises equipment from a communication network

(76) Inventors: Deborah Lewandowski Barclay, Winfield, IL (US); David S. Benco, Winfield, IL (US); Sanjeev Mahajan, Naperville, IL (US); Thomas Lee McRoberts, Naperville, IL (US); Raymond Leroy Ruggerio, Glenview, IL (US)

Correspondence Address: Docket Administrator (Room 3J-219), Lucent Technologies Inc., 101 Crawfords Corner Road, Holmdel, NJ, 07733-3030, US

(21) Appl. No.: 10/784,779

(22) Filed: Feb. 23, 2004

(51) Int. Cl. H04M 11/00

(52) U.S. Cl. 379/93.05; 379/93.01

(57) ABSTRACT

The present invention provides a method and apparatus for disconnecting a CPE from a communication network. When a CPE goes off-hook, the CPE is automatically disconnected from the communication network. An alert is provided at the CPE that indicates that the CPE has been disconnected from the communication network. When the CPE goes back on-hook, the CPE is automatically reconnected to the communication network. The alerting is then stopped at the CPE.

### FIELD OF THE INVENTION

The present invention relates generally to communication systems, and more particularly to a method and apparatus for determining if customer premises equipment has been left in an off-hook state.

### BACKGROUND OF THE INVENTION

Wireline telephone networks, such as the public switched telephone network (PSTN), provide subscribers with the ability to communication with other users. The wireline telephone network provides access to users, typically by providing a subscriber line to a premises, such as a home or business. The subscriber line normally includes multiple extensions that can be connected to the subscriber line. The extensions allow multiple CPEs to have access to the communication network using the same communication line. This allows multiple CPEs to be involved in a call.

One downside to having multiple CPEs connected to the PSTN is that one CPE can affect the operability of other CPEs on the same subscriber line. For example, wireline subscribers may inadvertently leave one of their phones off-hook. When a phone is left off-hook, no incoming calls can be completed and the line appears “dead” (i.e., no dial tone) for outgoing call attempts. Phones may be left in this state because of a previous call, such as when the call is answered with one extension but a different extension phone is used for the duration of the call. Other times a receiver may be accidentally knocked off the base unit, resulting in the CPE being off-hook and the same condition results.

Therefore, a need exists for a method and apparatus that allows CPEs connected to a communication network via a subscriber line to continue operation when one of the CPEs on the subscriber line has been left in an off-hook state.

### BRIEF SUMMARY OF THE INVENTION

The present invention provides a method and apparatus for disconnecting an off-hook customer premises equipment (CPE) from a communication network. In a first exemplary embodiment of the present invention, a CPE automatically detects when it has been left in an off-hook state. The CPE detects that it has been left in an off-hook state by detecting a receiver off-hook (ROH) tone. The CPE will disconnect itself from the subscriber line, thereby allowing other phones in the premises to continue functioning. The CPE provides an alert, such as a flashing light or audible tone, on the CPE that the CPE has been disconnected from the communication network. The CPE will also automatically reconnect the CPE to the communication network and stop the alerting when the CPE goes back on-hook.

In a second exemplary embodiment of the present invention, a receiver off-hook detection apparatus disconnects an off-hook CPE from the communication network, thereby allowing other CPEs on the subscriber line to continue to place and receive calls. The receiver off-hook detection apparatus includes an input port for receiving a plurality of tones from a communication network and a processor for determining if any of the tones received is a receiver off-hook (ROH) tone. The receiver off-hook detection apparatus is able to connect a plurality of CPES to the communication network, and is able to determine which of a plurality of CPEs connected to the receiver off-hook detection apparatus is off-hook. The receiver off-hook detection apparatus disconnects the off-hook CPE from the communication network, and provides an alert to the CPE that the CPE has been disconnected from the communication network. The receiver off-hook detection apparatus is able to determine when the phone goes back on-hook.

### BRIEF DESCRIPTION OF THE SEVERAL VIEWS OF THE DRAWINGS

FIG. 1 depicts a communication system including a CPE with receiver off-hook protection and a receiver off-hook detection apparatus in accordance with an exemplary embodiment of the present invention.

FIG. 2 depicts the receiver off-hook detection apparatus of FIG. 1 in accordance with an exemplary embodiment of the present invention.

FIG. 3 depicts a flowchart of a method for disconnecting a CPE (customer premise equipment) from a communication network in accordance with an exemplary embodiment of the present invention.

### DETAILED DESCRIPTION OF THE INVENTION

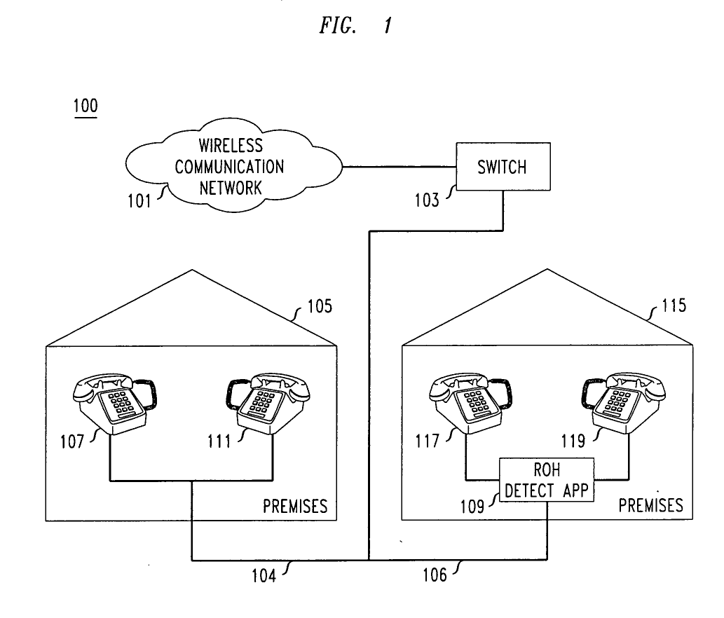

The present invention can be better understood with reference to FIGS. 1 through 3. FIG. 1 depicts a communication system 100 that includes a PSTN (Public Switched Telephone Network) 101, switch 103, premises 105, and premises 115.

Wireline communication network 101 is preferably a public switched telephone network (PSTN). Wireline communication network 101 provides communication to a plurality of wireline users, only four of which, CPE 107, CPE 111, CPE 117, and CPE 119, are depicted for clarity.

Switch 103 is connected to PSTN 101. In a preferred embodiment, there are a plurality of switches connected to PSTN 101, and each of the plurality of switches provide access for a plurality of CPEs to PSTN 101. In an exemplary embodiment of the present invention, switch 103 is a 5E/SS SWITCH provided by LUCENT TECHNOLOGIES INC.

Premises 105 is typically a house or other building, such as an office building, school, church, or any other building that is connected to PSTN 101 by switch 103 via communication line 104. In an exemplary premises, a single communication line 104 runs to premises 105. For CPEs connected to a phone line, the CPEs are able to participate in the same call. If one of the CPEs is left off-hook after a call ends, however, not only is the off-hook CPE unable to make or receive a call, but all other CPEs connected to the same phone line are prevented from making or receiving calls.

Premises 105 is depicted with two customer premises equipment, CPE 107 and CPE 111. CPE 107 is a telephone that does not have receiver off-hook detection capabilities. CPE 111 is a telephone that includes receiver off-hook detection functionality. In accordance with an exemplary embodiment of the present invention, if CPE 107 is left off-hook, CPE 111 will not be able to place or receive a phone call until CPE 107 is physically returned to an on-hook state or is physically disconnected from wireline communication network 101.

CPE 111 does include ROH detection capabilities. In an exemplary embodiment of the present invention, if CPE 111 is left in an off-hook state, CPE 111 will disconnect itself from wireline communication network 101 without physical intervention from a user. In this exemplary embodiment, CPE 111 detects an ROH tone, also known as a howler tone, generated by wireline communication network 101. Upon detecting the ROH tone, CPE 111 will disconnect from wireline communication network 101. In this manner, the customer line into premises 105 is not disabled, and CPE 107 is able to receive and place calls to other communication units.

Premises 115 includes CPEs 117 and 119 and receiver off-hook (ROH) detection apparatus 109. Premises 115 is connected to switch 103 via subscriber line 106. CPEs 117 and 119 are typical CPEs, and as such do not include receiver off-hook detection functionality. CPEs 117 and 119 are connected to ROH detection apparatus 109.

ROH detection apparatus 109 receives subscriber line 106 for premises 115. ROH detection apparatus 109 listens for an ROH tone from wireline communication network 101. ROH detection apparatus 109 detects the ROH tone and determines which CPE has been left in an off-hook state. ROH detection apparatus 109 then disconnects the off-hook CPE from the communication network so that the other CPE can still place and receive calls.

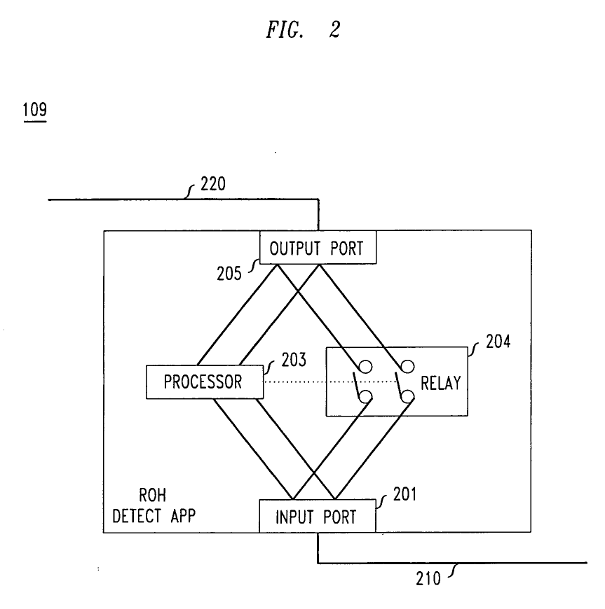

FIG. 2 depicts receiver off-hook detection apparatus 109 of FIG. 1 in greater detail in accordance with an exemplary embodiment of the present invention. Receiver off-hook detection apparatus 109 comprises input port 201, processor 203, relay 204, and output port 205.

Input port 201 is connected to a subscriber line at a premises and receives signals and tones from switch 103 and PSTN 101. Input port 201 passes the signals and tones received to processor 203.

Processor 203 receives the signals and tones sent by input port 201. In an exemplary embodiment of the present invention, processor 203 determines if a tone received is a receiver off-hook (ROH) tone. Normally the line voltage measured across a POTS (Plain Old Telephone Service) phone line is approximately 48 volts DC. When the phone is off-hook, the voltage drops down to approximately 3 to 9 volts. When this voltage drop occurs, processor 203 will begin monitoring for the ROH tone. A custom filter that can detect the defined ROH tone will trigger the processor to open the circuit that is normally closed by relay 204. If processor 203 receives a receiver off-hook (ROH) tone, processor 203 determines which of the CPEs is currently off-hook, preferably by testing each CPE from output port to CPE and back and detecting the loop of each on-hook CPE. Processor 203 then disconnects the off-hook CPE from the wireline network by activating relay 204 for the CPE that is off-hook.

Output port 205 is connected to a CPE at the premises. In a preferred embodiment, output port 205 is able to connect to a plurality of CPEs, and to differentiate between signals sent and received from each of the CPEs. In an exemplary embodiment, each output port will have a separate relay, which allows for CPEs to be individually disconnected.

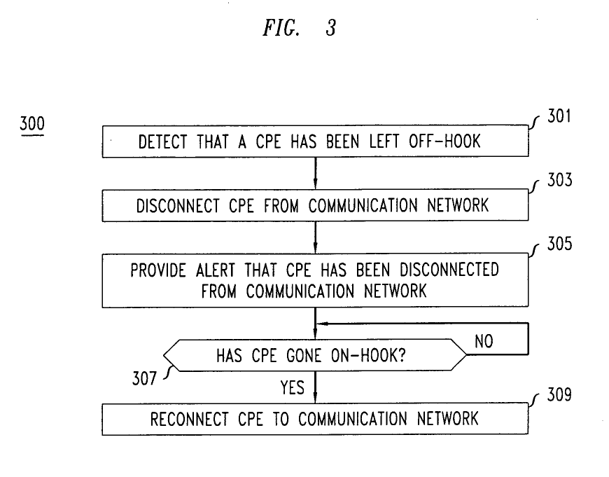

FIG. 3 depicts a flowchart 300 of a method for disconnecting a CPE from a communication network in accordance with an exemplary embodiment of the present invention.

In an exemplary embodiment of the present invention, a CPE detects (301) that the CPE has been left in an off-hook state. In a further exemplary embodiment, a Receiver Off-Hook (ROH) detecting apparatus detects that a CPE connected to the ROH detection apparatus has been left off-hook.

The step of detecting that a CPE has gone off hook comprises detecting a receiver off-hook (ROH) tone. The communication network, preferably via the central office, initially plays a prerecorded announcement that asks the subscriber to either hang up the CPE or dial the operator for assistance. If the subscriber does not hang up the CPE (return the CPE to an on-hook state), the communication network generates a Receiver Off Hook (ROH) tone, also known as a howler tone. The ROH tone utilizes four different frequencies. In the United States, the frequencies are 1400 Hz, 2060 Hz, 2450 Hz, and 2600 Hz. Other tones can be used in accordance with the present invention.

The CPE is then disconnected (303) from the communication network. The ROH detection device closes the open loop within the device utilizing a switch that bypasses the ROH CPE. By disconnecting the CPE from the communication network, the subscriber line is returned to an on-hook state, thereby allowing other CPEs at the premises to respond to incoming calls and to place outgoing calls normally.

In one exemplary embodiment of the present invention, an alert is provided (305) by the CPE. The alert indicates to a user at the premises that the CPE has been disconnected from the communication network. The alert can be audible, visual, or vibrating. For example, a tone can be generated by the CPE that has been disconnected. This tone can be constant or periodic, and can increase in frequency or intensity as time goes on. A visual indicator can be lit at the CPE, such as an LED. The LED can be set to on when the CPE has been disconnected, or can be set to flash. Further, lights can be set on other CPEs located at the premises that indicate that another CPE at the premises has been disconnected from the communication network. In another exemplary embodiment, the CPE can be set to vibrate to alert a user at the premises that the CPE has been disconnected from the communication network.

It is then determined (307) if the CPE has gone on-hook, preferably by utilizing a test loop from the ROH detection apparatus to the off-hook CPE and back. Once the ROH tone is played for a fixed duration switch 103 will stop playing the tone and begin a low priority monitoring of the line to determine when the phone has been restored to the on hook state. If the CPE has not gone on-hook, the check of whether the CPE has gone on-hook continues.

When the CPE does go back on-hook, which is preferably detected by recognizing that the low-impedance condition has been corrected, the CPE is reconnected (309) to the communication network. This is preferably accomplished by having the internal device switch opened so that the ROH CPE is now part of the loop again. The alert that was provided for the CPE to indicate that the CPE has been disconnected from the communication network is stopped.

The present invention thereby provides a method and apparatus for automatically detecting that a CPE is off-hook and disconnecting the CPE from the wireline communication network. By detecting a receiver off-hook tone from the communication network, the off-hook CPE is able to be automatically disconnected from the communication network. This allows other CPEs in the same subscriber line to continue to place and receive calls.

The off-hook CPE generates an indication that it is off-hook, such as a tone or a visual indicator, such as a flashing LED. When the CPE goes back on-hook, the CPE is returned to service on the subscriber line and is able to be used to place and receive calls.

While this invention has been described in terms of certain examples thereof, it is not intended that it be limited to the above description, but rather only to the extent set forth in the claims that follow.

1. A method for disconnecting a CPE (customer premise equipment) from a communication network, the method comprising:
detecting that the CPE has been left in an off-hook state; and
automatically disconnecting the CPE from the communication network.

2. A method for disconnecting a CPE from a communication network in accordance with claim 1, the method further comprising the step of providing an alert on the CPE that the CPE has been disconnected from the communication network.

3. A method for disconnecting a CPE from a communication network in accordance with claim 2, wherein the step of providing an alert on the CPE comprises flashing a light on the CPE.

4. A method for disconnecting a CPE from a communication network in accordance with claim 2, wherein the step of providing an alert on the CPE comprises generating a tone at the CPE.

5. A method for disconnecting a CPE from a communication network in accordance with claim 1, wherein the step of detecting that the CPE has been left in an off-hook state is done at the CPE.

6. A method for disconnecting a CPE from a communication network in accordance with claim 1, wherein the step of detecting that the CPE has been left in an off-hook state is done in a receiver off-hook detection unit.

7. A method for disconnecting a CPE from a communication network in accordance with claim 1, wherein the step of detecting that the CPE has been left in an off-hook state comprises detecting a receiver off-hook (ROH) tone.

8. A method for disconnecting a CPE from a communication network in accordance with claim 1, the method further comprising the step of detecting that the CPE has gone on-hook.

9. A method for disconnecting a CPE from a communication network in accordance with claim 8, the method further comprising the step of reconnecting the CPE to the communication network.

10. A method for disconnecting a CPE from a communication network in accordance with claim 8, the method further comprising the step of stopping alerting when the CPE has gone on-hook.

11. A receiver off-hook detection apparatus comprising:
an input port for receiving a plurality of tones from a communication network; and
a processor for determining if any of the plurality of tones received from the communication network is a receiver off-hook (ROH) tone.

12. A receiver off-hook detection apparatus in accordance with claim 11 further comprising means for determining which of a plurality of CPEs connected to the receiver off-hook detection apparatus is off-hook.

13. A receiver off-hook detection apparatus in accordance with claim 12 further comprising:
means for disconnecting the off-hook CPE from the communication network; and
wherein the processor further provides an alert to the CPE that the CPE has been disconnected from the communication network.

14. A CPE (customer premises equipment) comprising:
an input port that connects the CPE with a communication network; and
a processor that disconnects the CPE from the communication network when the CPE is off-hook.

15. A CPE in accordance with claim 14, wherein the processor detects when the CPE returns to an on-hook state and automatically reconnects the CPE to the communication network.

16. A CPE in accordance with claim 14, wherein the processor provides an alert on the CPE that the CPE has been disconnected from the communication network.

17. A CPE in accordance with claim 16, wherein the alert on the CPE comprises flashing a light on the CPE.

18. A CPE in accordance with claim 16, wherein the alert on the CPE comprises generating a tone at the CPE.

19. A CPE in accordance with claim 16, the method further comprising the step of stopping alerting when the CPE has gone on-hook.

20. A CPE in accordance with claim 14, wherein the processor detects that the CPE is off-hook by detecting a receiver off-hook (ROH) tone.
